(19) United States
(12) Patent Application Publication
(10) Pub. No.: US 2002/0166821 A1
(43) Pub. Date: Nov. 14, 2002

(54) Disc filters with shower systems and methods of use

(76) Inventor: Peter J. Flanagan, Sandy, UT (US)

Correspondence Address: TRASK BRITT, P.O. BOX 2550, SALT LAKE CITY, UT, 84110, US

(21) Appl. No.: 10/125,837

(22) Filed: Apr. 19, 2002

Related U.S. Application Data
(60) Provisional application No. 60/285,858, filed on Apr. 23, 2001.
(60) Provisional application No. 60/302,724, filed on Jul. 3, 2001.

(51) Int. Cl. B01D 33/06

(52) U.S. Cl. 210/784; 210/402

(57) ABSTRACT

A disc-type filtration apparatus including at least one filter element and a shower system configured to wash media portions on sides the at least one filter element as the filter element moves rotationally downward toward and into a slurry reservoir and subsequent to scraping of filter cake therefrom. The shower system may be fixed and extend across the sides of the filter element or, alternatively, the shower system may include a movable head which is caused to traverse radially across the sides of the filter element. The shower system may be operated on a discontinuous or periodic basis or, optionally, on a continuous basis. Methods of operation of a filtration apparatus are also disclosed.

### CROSS-REFERENCE TO RELATED APPLICATIONS

This application claims the benefit of U.S. provisional patent application, Serial No. 60/285,858 filed Apr. 23, 2001 and U.S. provisional patent application, Serial No. 60/302,724 filed Jul. 3, 2001.

### BACKGROUND OF THE INVENTION

1. Field of the Invention

The present invention relates generally to disc-type filters and, more particularly, to those including a shower system for washing a portion of at least one filter element of excess precoat material prior to re-immersion of the disc portion in a slurry or sludge reservoir for formation of filter cake thereon.

2. State of the Art

Filters for separating solid particles from suspensions or slurries are well known in the art. Rotating drum-type filters as well as rotating disc-type filters are conventional, and both types of filters use a pressure differential between the interior and exterior of a filter element to pull such particulates to form a filter cake against the exterior of the filter element (drum or disc), the filter cake then being removed from the exterior of the filter element.

Examples of drum-type filters are disclosed in U.S. Pat. No. 3,521,751, U.S. Pat. No. 5,759,397, U.S. Pat. No. 5,968,372, European Patent Specification EP 0 454 392 B1, International Patent Application Publication No. WO 94/23821 and German Patent Application No. DE 30 47 539 A1. Examples of disc-type filters are disclosed in U.S. Pat. No. 1,804,934, U.S. Pat. No. 5,759,397 and U.S. Pat. No. 6,063,294.

The foregoing types of filters are extensively employed in lime mud filtration, wherein the filter element is used to thicken lime sludge by drawing the sludge under the aforementioned pressure differential against a precoat layer of lime sludge subsisting on the exterior of the filter element. The mud drawn onto the filter element forms the filter cake which is then scraped from the exterior of the filter element, leaving the underlying precoat layer in place. After time, the precoat layer on the filter element becomes less permeable and inhibits, rather than assists, the filtering operation which forms the filter cake. At that point, it is necessary to remove the precoat layer and then reestablish same on the filter element.

It is known with drum filters to wash the precoat from a portion of a rotating drum filter element on a continuous basis or on a discontinuous, or periodic, basis before that portion of the drum moves downwardly and enters the slurry or sludge reservoir for recoating. It is also known to wash the precoat from a portion of a rotating drum filter element on a discontinuous, or periodic, basis as that portion moves upwardly after passing through the slurry or sludge reservoir.

It is also known with disc filters to wash the precoat from a portion of a rotating disc on a discontinuous, or periodic, basis as that portion moves upwardly after passing through a slurry or sludge reservoir. In one conventional arrangement, a traversing or oscillating shower head is employed on a discontinuous, or periodic, basis to wash the side of the filter element between the radially interior and radially exterior boundaries thereof. The shower head may be moved at a constant rate, or at a variable rate so as to apply less water to the radially interior portion of the filter element than to the radially exterior portion, which exhibits a far greater surface area.

It would be desirable to provide a shower system for washing a portion of a disc-type filter element as it rotates downwardly and prior to entry into the slurry or sludge reservoir, and immediately after removal of the filter cake therefrom so that the filter cake is retained on the filter element exterior as long as possible to maximize dewatering of the filter cake. It would also be desirable to perform washing of the disc-type filter element on a substantially continuous basis during the downward rotation and prior to entry thereof into the reservoir to enhance precoat consistency and uniformity of filtration performance.

### BRIEF SUMMARY OF THE INVENTION

The present invention comprises disc-type filtration apparatus including a shower system for washing at least one disc-type filter element and configured to wash media portions on the sides of the filter element as the filter element moves rotationally downward toward and into a slurry reservoir and subsequent to scraping of filter cake therefrom. In one embodiment, the shower system is fixed in position about both sides of the filter element and extends from the radially interior boundary to the radially exterior boundary of each of the media portions. In another embodiment, the shower system includes a movable head on each side of the filter element, which heads are caused to traverse between the radially interior and exterior boundaries of the media portions. The shower system of the present invention may be operated on a discontinuous or periodic basis or, optionally, on a continuous basis. Methods of operation of a filtration apparatus are also encompassed by the present invention.

### BRIEF DESCRIPTION OF THE SEVERAL VIEWS OF THE DRAWINGS

FIG. 1 is a schematic side elevation of a first embodiment of the filtration apparatus of the present invention;

FIG. 2 is a schematic top elevation of a multi-disc filtration apparatus in accordance with the first embodiment of the present invention; and

FIG. 3 is a side schematic elevation of a second embodiment of the filtration apparatus of the present invention.

### DETAILED DESCRIPTION OF THE INVENTION

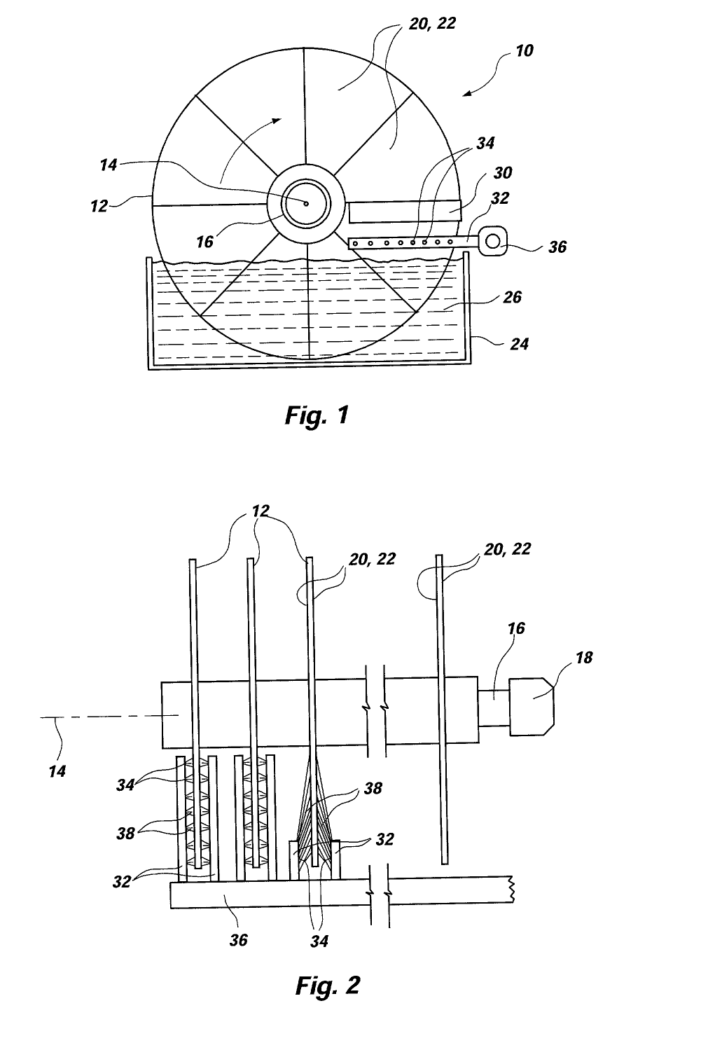

Referring to FIGS. 1 and 2 of the drawings, an exemplary filtration apparatus 10 according to the present invention and including a plurality of disc-shaped filter elements 12 is depicted. Filter elements 12 are oriented transverse to and laterally spaced along an axis of rotation 14, filter elements 12 being mounted to a tubular drive mandrel 16 which is rotatable by a drive 18, all as known in the art. The disc-shaped filter elements 12 include first and second substantially parallel sides 20 each including a media portion 22 which extends from an interior radial boundary to an exterior radial boundary. Media portions 22 may comprise screens, filter cloths, or combinations thereof as known in the art. Under rotation of drive mandrel 16 by drive 18, the filter elements 12 are rotated into and out of a reservoir 24 containing a slurry 26 such as, for example, lime mud to coat media portions 22 with the slurry 26. Responsive to a positive pressure differential between the exteriors of filter elements 12 and the interiors thereof, the slurry 26 in the reservoir 24 is drawn to form a filter cake 28 against the media portions 22, which are covered with a precoat of the solids portion of the slurry 26. As known in the art, the positive pressure differential may be created by drawing a vacuum on the interior of filter elements 12 through tubular drive mandrel 16, or by enclosing the filtration apparatus within a pressure vessel and increasing pressure within the vessel relative to the pressure on the interior of the filter elements 12.

The filter cake 28 overlying the media portions 22 is removed from the media portions 22 as the filter elements 12 rotate downwardly toward reservoir 24 using scraper elements 30 flanking the first and second sides 20 of the filter elements 12. A shower system including first and second conduits 32 respectively flanking the first and second sides 20 of the filter elements is disposed with respect to filter cake removal elements in the form of scrapers 30 so that an outlet or outlets 34 of each conduit 32 are located therebelow. A single outlet 34 in the form of a nozzle may be associated with each of the first and second conduits 32 and oriented to direct fluid flow 38 from a manifold 36 in communication with a fluid source (not shown) against and across a media portion 22 of an adjacent filter element side 20. Alternatively, a plurality of outlets 34 may be employed along a conduit 32 extending radially inwardly along a filter element side 20. In the latter instance, differently-sized outlets 34 may be employed to direct different volumes of fluid flow against radially offset segments of media portions 22 so that the radially outer portions thereof receive greater flow than radially inner portions thereof. A plurality of valves (not shown) may be interposed between manifold 36 and conduits 32 to open and close fluid flow therebetween, and to cycle fluid to each disc filter periodically if the shower system is not to be continuously operated. If desired, the shower system may be operated so as to wash one side of a filter element 12 at a time in a periodic manner so as to, for example, wash each side of each filter element sequentially until all filter elements 12 in a bank of filter elements 12 of a bank comprising filtration apparatus 10 have been washed, to wash one side of all filter elements concurrently and then the other side, or to employ some other was sequence. Remotely, automatically controlled valves controlling fluid flow to each conduit 32 from a manifold 36 may be programmed to effectuate any wash cycle desired by the operator.

In operation, filtration apparatus 10 rotates drive mandrel 16 using drive 18 to rotate filter elements 12 into and out of slurry 26 is reservoir 24. As the filter elements 12 rotate out of the slurry 26, the pressure differential which has drawn slurry against the precoat on media portions 22 continues to remove slurry liquid into the interiors of the filter elements 12 and consolidate the filter cake 28 against media portions 22. After the filter elements 12 commence a downward rotation back toward reservoir 24, scraper elements 30 extending radially across the media portions 22 are employed to remove filter cake therefrom down to a thickness of precoat material thereon, the precoat comprising substantially the same material as the slurry but in dewatered form. Subsequent to scraping of the media portions 22, first and second conduits 32 direct fluid flow 38 using outlet or outlets 34 against the precoat residing on the media portions 22 to remove and condition precoat material thereon to maintain the porosity of the precoat and enhance the uniformity of same prior to reentry into slurry 26. The washing of precoat on the media portions 22 may be effected on a continuing basis or on a discontinuous, or periodic, basis, as desired or indicated by the constituency of the slurry, filter element rotational speed, type of media employed, etc.

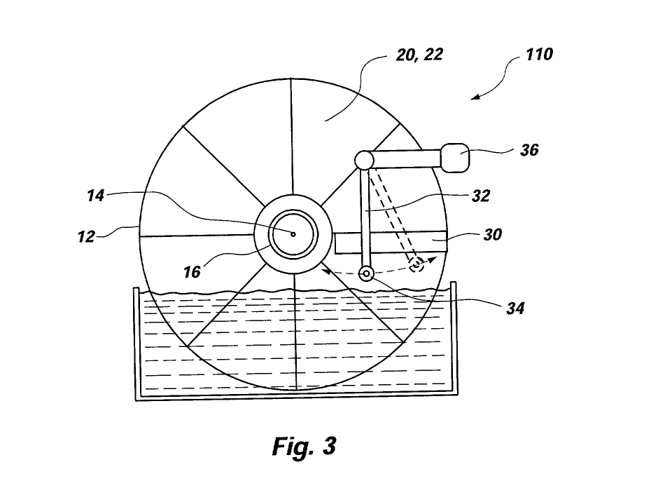

FIG. 3 depicts a second embodiment 110 of the filtration apparatus of the present invention, wherein like features and elements are identified by the same reference numerals as in FIGS. 1 and 2. Embodiment 110 is similar to embodiment 10, with the exception that the shower system for removing and treating the precoat is structured so that first and second conduits 132 are configured so that outlets 34 are movable across the media portions 22 of first and second sides 20 of the filter elements 12. The movement may be effected by swinging one end of each conduit 32 through an arc about the other end, in the manner shown in FIG. 3 is broken lines and as set forth in more detail in the previously-mentioned U.S. Pat. No. 6,063,294, the disclosure of which is hereby incorporated by reference. Alternatively, conduits 32 may be configured to linearly traverse media portions 2 between their radially interior boundaries and radially exterior boundaries through the use of a dual-action hydraulic or pneumatic cylinder, a linear screw drive, or other suitable drive mechanism as known in the art. In such an arrangement, conduits 32 may comprise flexible high pressure conduits having an outlet 34 in the form of a nozzle which is secured to and moved by the drive mechanism.

While the present invention has been disclosed in terms of certain illustrated embodiments, those of ordinary skill in the art will recognize and appreciate that additions, deletions and modifications to the disclosed embodiments without departing from the scope of the invention as defined by the claims which follow.

What is claimed is:

1. A filtration apparatus comprising:
at least one rotatable disc-shaped filter element having a first side and a second, substantially parallel side, both sides oriented transverse to an axis of rotation, each side including a media portion;
a reservoir below the at least one rotatable disc-shaped filter element, the reservoir positioned so as to extend above a lower portion thereof;
a drive operably coupled to the at least one disc-shaped filter element for rotation thereof in a selected direction about the axis of rotation;
a first conduit adjacent the first side of the at least one disc-shaped filter element, the first conduit including at least one outlet associated therewith for directing a flow of fluid from the first conduit toward the first side of the at least one disc-shaped filter element and onto the media portion thereof;
a second conduit adjacent the second side of the at least one disc-shaped filter element, the second conduit including at least one outlet associated therewith for directing a flow of fluid from the first conduit toward the first side of the at least one disc-shaped filter element and onto the media portion thereof; and
first and second filter cake removal elements disposed respectively above the at least one outlet of each of the first and second conduits.

2. The filtration apparatus of claim 1, wherein the first and second conduits are located to flank the at least one disc-type filter element as a portion thereof moves downwardly therebetween responsive to rotation of the at least one disc-type filter element in the selected direction responsive to the drive.

3. The filtration apparatus of claim 2, wherein the first and second conduits are fixed and extend substantially transverse to the axis of rotation at least from a radially interior boundary of each of the media portions to a radially exterior thereof.

4. The filtration apparatus of claim 3, wherein the filter cake removal elements comprise scrapers.

5. The filtration apparatus of claim 2, wherein the first and second conduits include at least portions thereof which are movable and exhibit a travel sufficient to traverse the at least one outlet between locations adjacent radially interior boundaries of the each of the media portions to adjacent radially exterior portions thereof.

6. The filtration apparatus of claim 5, wherein the filter cake removal elements comprise scrapers.

7. The filtration apparatus of claim 2, wherein the filter cake removal elements comprise scrapers.

8. A method of operating a filtration apparatus comprising:
providing at least one rotatable disc-shaped filter element having a first side and a second, substantially parallel side, each side including a media portion and oriented transverse to an axis of rotation;
rotating the at least one rotatable disc-shaped filter element about the axis of rotation in a selected direction to sequentially immerse portions of the disc-shaped filter element a slurry contained in a reservoir below the at least one disc-shaped filter element; and
washing the media portions of the first and second sides prior to immersion thereof in the slurry and as the at least one rotatable disc-shaped filter element rotates downwardly thereinto.

9. The method of claim 8, further comprising removing filter cake from the media portions of the first and second sides of the at least one rotatable disc-shaped filter element prior to the washing thereof.

10. The method of claim 9, wherein removing the filter cake is effected during downward rotation of the at least one rotatable disc-shaped filter element into the slurry.

11. The method of claim 8, further including washing the media portions of the first and second sides with at least one stream of fluid emanating from a fixed location.

12. The method of claim 8, further including washing the media portions of the first and second sides with at least one stream of fluid traversing at least a portion of a distance between radially interior and radially exterior boundaries of the media portions.

13. The method of claim 8, wherein washing the at least one media portion of at least one of the first and second sides further comprises removing precoat material therefrom.

14. The method of claim 13, wherein washing the at least one media portion of at least one of the first and second sides further comprises cleaning the at least one media portion from which precoat material has been removed.

15. The method of claim 8, wherein washing the at least one media portion of at least one of the first and second sides further comprises cleaning the at least one media portion.

16. The method of claim 8, wherein washing the at least one media portion of at least one of the first and second sides is effected in a substantially continuous manner.

17. The method of claim 8, wherein washing the at least one media portion of at least one of the first and second sides is effected in a periodic manner.
